(19) United States
(12) Patent Application Publication
(10) Pub. No.: US 2009/0152397 A1
(43) Pub. Date: Jun. 18, 2009

(54) SELECTIVE RELEASE LATCH

(75) Inventor: Richard James LaConte, Black Diamond, WA (US)

Correspondence Address: JENSEN + PUNTIGAM, P.S., 2033 6th Ave, Suite 1020, SEATTLE, WA, 98121, US

(73) Assignee: Harper Engineering Co., Renton, WA (US)

(21) Appl. No.: 11/955,762

(22) Filed: Dec. 13, 2007

(51) Int. Cl. B64C 1/14

(52) U.S. Cl. 244/129.4

(57) ABSTRACT

A selectively released latch securing a panel in position, but which resists release in response to sudden movement of the panel, yet allowing release in response to a slow and steady movement of the panel.

### TECHNICAL FIELD

This invention relates to release latches, particularly those designed for airplane ceiling panels, and more particularly to a latch which will secure a panel in place, not yielding to sudden movements but releasing the panel following a continued steady pressure.

### BACKGROUND OF THE INVENTION

It is known to have adjustable pressure or blow-off latches for use on the exterior of an airplane, as taught by U.S. Pat. No. 5,765,883 granted to Dessenberger et all Jun. 16, 1998; U.S. Pat. No. 6,513,841 granted to Jackson, Feb. 4, 2003; and U.S. Pat. No. 6,755,448 granted to Jackson et al, Jun. 29, 2004.

Interior aircraft panels and load regulating latches are also known, as taught by U.S. Pat. No. 4,739,955 granted to Aquino, Apr. 26, 1988; U.S. Pat. No. 4,045,063 granted to Fletcher et al, Aug. 30, 1977; sand U.S. Pat. No. 6,866,226 granted to Pratt et al, Mar. 15, 2005. It is assumed that each of these latches operate in the manner described, which is primarily to release a panel upon a pre-determined change in pressure or adjust loads of structures in response to a change in pressure caused by rapid movements or the like.

### DISCLOSURE OF THE INVENTION

It is a feature of the present invention that the selective release latch incorporates a structure, including a damping means, which prevents the latch from unlatching in response to a sudden movement and yet allows unlatching in response to a slow, steady pressure. The latch prevents an accidental unlatch as a result of jostling and/or bumping, but permits an unlatch generated by a slow, steady pressure.

Another feature of the present invention is a latch which prevents access to the area behind a panel because of curiosity or inadvertent jostling, and yet permits access, when necessary, for maintenance or the like.

Still a further feature of the present invention is a latch wherein release may be obtained from the opposite side of the panel from the latch, thus not requiring a person seeking release to insert their hands into generally unacceptable or dangerous places.

### BRIEF DESCRIPTION OF THE DRAWINGS

FIG. 1 is an environmental view depicting a typical aircraft ceiling panel in position and held in position by a latch mechanism at each edge of the panel, the lower one being designed for selective release and the upper one being designed for automatic release responsive to a sudden pressure change.

FIGS. 2A and 2B depict a selective release latch in the unlatched and the latched position, respectively.

FIGS. 3A, 3B and 3C are elevational views depicting the latch in the unlatched position (3A), the latched position (3B) and the position to unlatch (3C).

FIG. 4 is an exploded view of the inventive latch mechanism.

FIGS. 5A-D display the inventive latch in the various stages of operation.

### BEST MODE FOR CARRYING OUT THE INVENTION

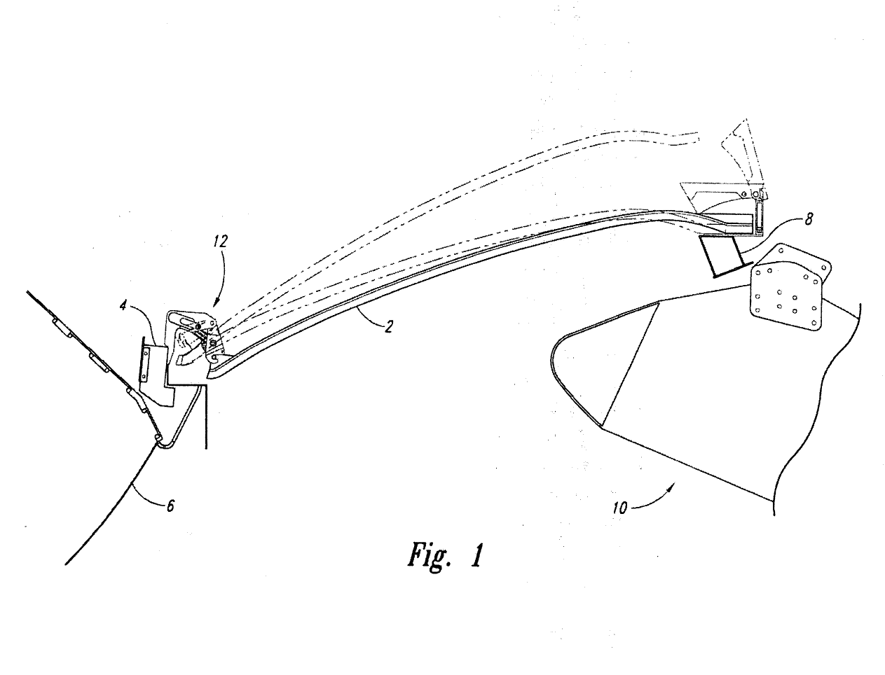

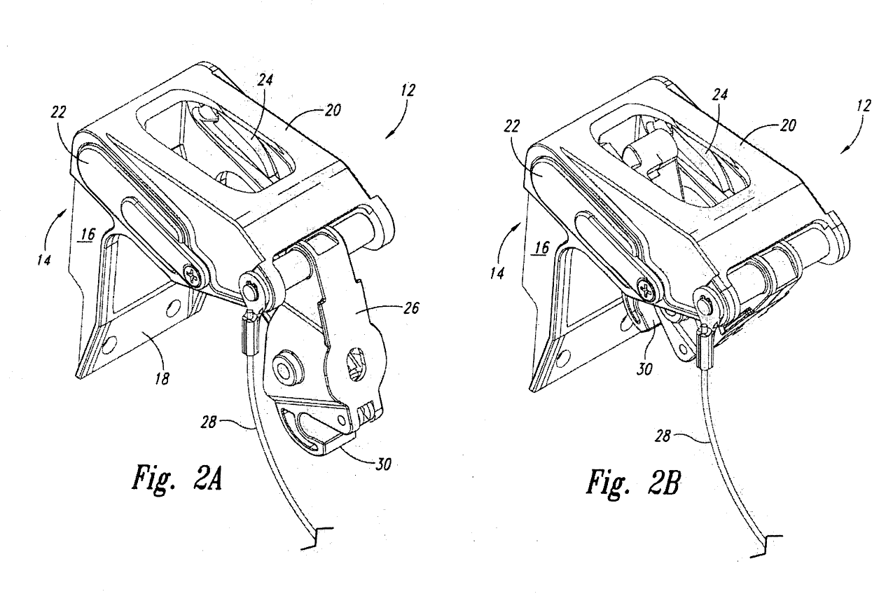

As seen in FIG. 1, the curved ceiling panel 2 essentially extends from a side framing element 4 secured to an overhead rack 6, or the like, to the opposite end of the panel, wherein a framework 8 is likewise secured to an overhead bin 10. As schematically shown in this view, upon a sudden change in pressure, the panel 2 will be released at its upper end. The lower end, however, as explained hereinafter, is secured by a selectively unlatched latch which does not respond to sudden changes in pressure.

Latch 12, as seen in the following figures, includes an inverted L-shaped main body portion 14 having a lower leg 16 including a cross-member 18 by which the latch is secured to the framework. The inverted L-shaped bracket includes an outwardly extending leg 20, which includes as a part thereof an escapement 22, including on its inner side a cam groove 24, as explained hereinafter. A latch element 26 terminating in a lower jaw 30 is pivotably secured to the outer end of the leg 20. Likewise seen in this view is a lanyard 28 which prevents the panel from falling free when released.

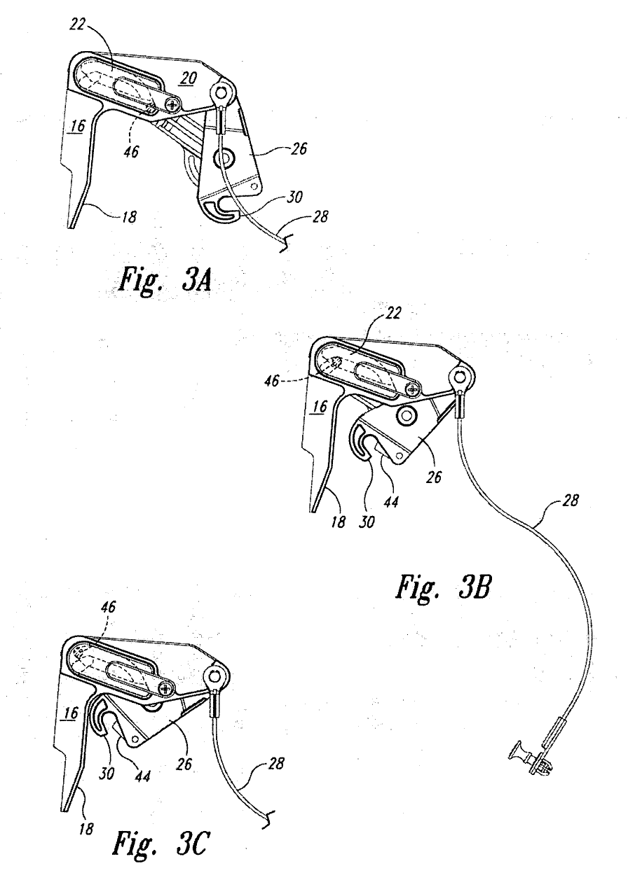

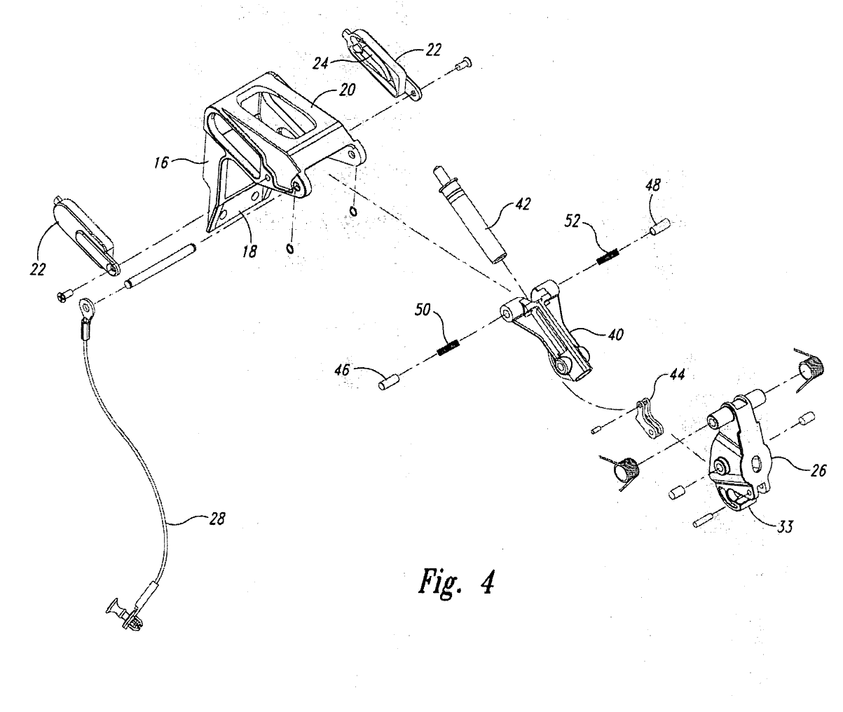

Reference is now had to FIGS. 3 and 4, where it can be seen that the link member 40 containing a damper 42 and cam 44 extends between the rod 26 and the back of the bracket 22. Followers 46 and 48, pushed outwardly by springs 50 and 52, extend into cam groove 24 and follow it, as shown, in FIG. 3, wherein the unlock position follower 46 is at the bottom of the cam groove. In the locked position 3B it is in the recessed portion and in the unlock position 3C it is moved upwardly, allowing the follower to reverse direction back to the open position. Likewise seen in FIGS. 3B and 3C, cam 44 serves to retain a loop (not shown), secured to the upper part of the panel, in position.

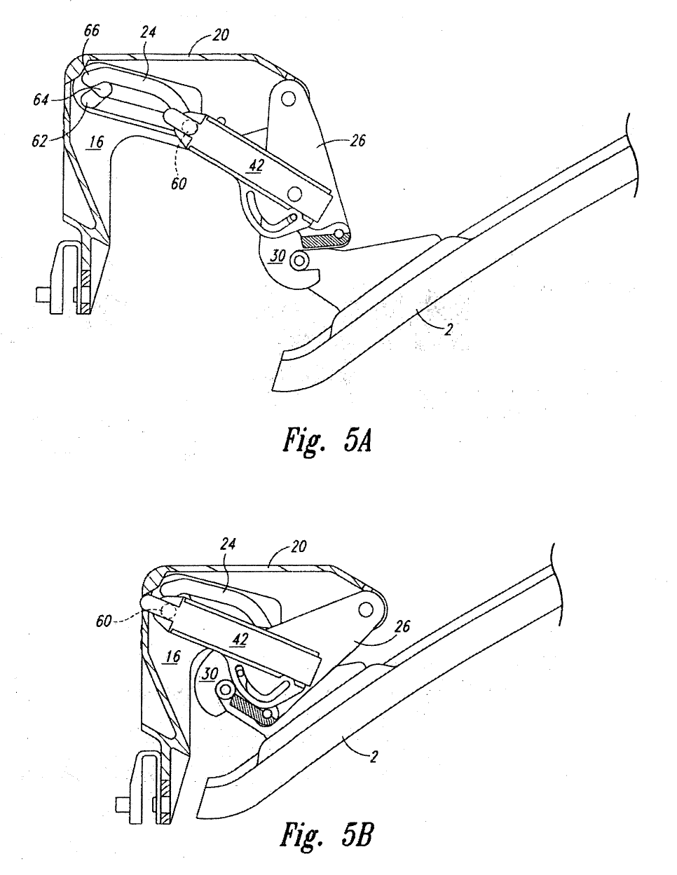

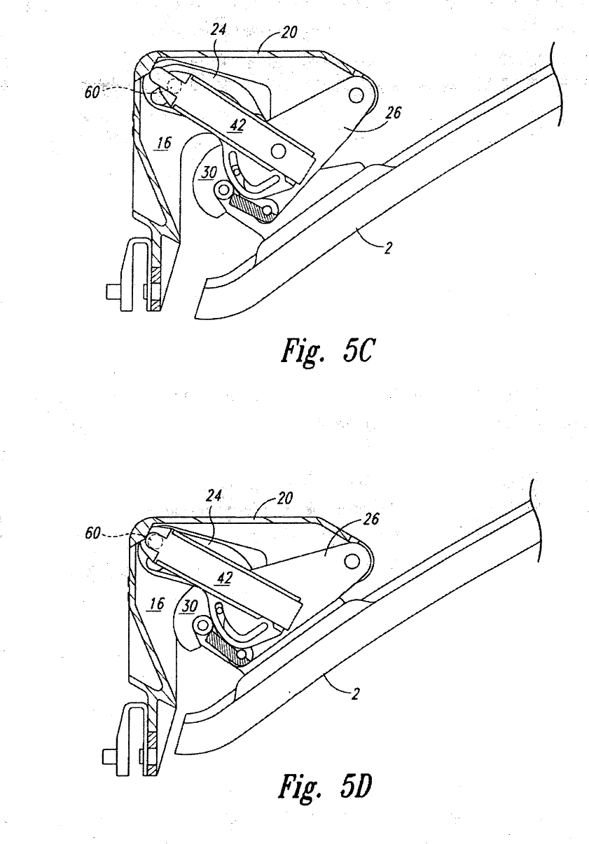

As seen in FIGS. 5A-D, the latch is shown in the unlatched position (in 5A), ready for the installation or removal of a panel. Likewise seen in this view are the cam positions for the follower location, and in particular the unlatched detent 60, the initial latching detent 62, the final latched detent 64 and the initial unlatching detent 66

Reference is now had to FIG. 5B, wherein it can be seen that the damper 42 is uncompressed and that the panel is being moved to the initial latched position.

Reference is now had to FIG. 5C, wherein the damper is in its final position and is uncompressed; whereas in FIG. 5C, the damper 42 is compressed and the latch is ready to go to the final unlatching position (shown in FIG. 5A).

It can be seen that the inventive bracket allows the ceiling panel to be secured to the bracket latched in place and will remain in place until the panel is slowly moved to the release or preparation for unlatch position

Although a preferred embodiment of the invention has been disclosed here for the purposes of illustration, it should be understood that various changes, modifications and substitutions may be incorporated in the embodiment without departing from the spirit of the invention, which is defined by the claims which follow.

What is claimed is:

1. A release latch allowing selective access to the area behind a secured panel, comprising:
a substantially L-shaped body portion with one leg of the L secured to a substantially vertical stable portion of a relatively fixed object and the second leg extending perpendicularly outwardly therefrom;
a linking member pivotably mounted to the outer end of the second leg movable from an unlatched position, substantially perpendicular to the second leg, to a latched position, said linking member including a curved groove guiding a latch means to the latched position when the linking member is moved to the latched position; and
a dampening means mounted between the linking member and the body portion such that the release latch will only unlatch when the arm is moved slowly beyond the latched position.

2. A release latch as in claim 1, wherein the panel is suspended from the latch.

3. A release latch as in claim 1, wherein the inner end of the linking member follows a pair of opposing cams, moving from an unlatched position to a latched position, and wherein the latched position requires a steady pressure to overcome the dampening means to return to the unlatched position.
